(19) United States
(12) Patent Application Publication
(10) Pub. No.: US 2011/0256196 A1
(43) Pub. Date: Oct. 20, 2011

(54) Insecticide for Bed Bugs

(75) Inventors: Jeffrey D. Lloyd, Knoxville, TN (US); Kevin Kirkland, Knoxville, TN (US); Tracy D. Malone, Knoxville, TN (US)

(73) Assignee: NISUS CORPORATION, Knoxville, TN (US)

(21) Appl. No.: 13/164,859

(22) Filed: Jun. 21, 2011

Related U.S. Application Data
(63) Continuation-in-part of application No. 11/759,291, filed on Jun. 7, 2007, now abandoned.

(51) Int. Cl. A01N 25/34; A01P 7/02; A01P 7/00; A01N 59/14; A01P 7/04

(52) U.S. Cl. 424/403; 424/660

(57) ABSTRACT

The present disclosure provides a method for killing arthropods. According to one embodiment of the present disclosure, the method preferably includes providing a pesticide composition which includes from about 0.01 to about 0.8 percent, by weight, of a surfactant and from about 0.2 to about 15 percent, by weight, of a boron-containing component. The pesticide composition is applied to a absorbent material which is infested with arthropods, so that the pesticide composition is adsorbed by the absorbent material in an amount sufficient to kill arthropods. The arthropods contact the absorbent material and are killed by the adsorbed pesticide composition.

### CROSS-REFERENCE TO RELATED APPLICATIONS

This application is a continuation-in-part of application Ser. No. 11/759,291, filed Jun. 7, 2007, and entitled “Surface Cleaning Method and Composition”, the entire contents of which are herein incorporated by reference.

### FIELD

This invention relates to the field of cleaning compositions. More particularly, this invention relates to cleaning compositions having improved antimicrobial properties and a method for using such cleaning compositions.

### BACKGROUND

Floors and other hard surface in restaurants, bathrooms, hotels, schools, industrial plants and many other areas have both microbial and arthropod pest issues due to various contaminations caused by foot traffic, skin exfoliation, food and drink spillage or contamination and various other factors leaving microbe supporting and insect attracting agents on the surface. The typical method for controlling such pests and the resulting odor and health consequences has been by regular cleaning with water or water and detergent combinations. Such cleaning is somewhat effective, but invariably leaves behind a certain level of contamination, which can support the growth of various pest microbes and feed various arthropod pests such as cockroaches. Thus, there is a continuing need for more effective and longer lasting, cleaning methods and compositions.

In addition, there is a need for improved pesticides to kill arthropods, such as fleas, dust mites, and especially bed bugs.

### SUMMARY

The above and other needs are met by a cleaning method and composition according to the present disclosure.

In a first aspect, the present disclosure provides a method for treating a contaminated surface. According to one embodiment of the present disclosure, the method includes a microbial biocide and from about 0.05 to about 5 percent, by weight, of a boron-containing component which is capable of acting as both a microbial biostat and an insecticide. This cleaning composition is applied to the surface so as to substantially remove contaminants from the surface while leaving a residual amount of the cleaning composition on the surface to act as a biostat. The surface is then allowed to become at least partially recontaminated so that contaminants contact on the surface and mix with the residual cleaning composition on the surface to form an insecticidal bait effective to attract insects such that the insects ingest the insecticidal bait and die as a result.

In some embodiments according to the present disclosure, the step of applying the cleaning composition to the surface preferably also sanitizes the surface by killing microorganisms thereon. Potentially harmful bacteria, viruses, mold, and other pathogens may all be rapidly killed as well as arthropods such as insects.

In certain embodiments according to the present disclosure, the boron-containing component used in the method is preferably selected from the group consisting of disodium octaborate tetrahydrate, sodium pentaborate, sodium tetraborate, tincal, kernite, ulexite, boric acid, boronic acid, phenyl boronic acid, trihexylene glycol biborate and mixtures thereof. More preferably, the boron-containing wherein the boron-containing component is selected from the group consisting of disodium octaborate tetrahydrate and sodium pentaborate.

In certain other embodiments according to the present disclosure, the microbial biocide preferably includes a cationic surfactant and the cleaning composition comprises from about 0.002 to about 2 percent, by weight, of the cationic surfactant. The cationic surfactant may, for instance, be a quaternary ammonium salt. Suitable quaternary ammonium salts may be selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof.

In still other embodiments according to the present disclosure, the cleaning composition used in the method may further include from about 10 to about 4000 parts per million (ppm) of a chelating agent. In certain embodiments, this chelating agent is preferably a salt of ethylenediaminetetraacetic acid (EDTA).

In some embodiments according to the present disclosure, the residual cleaning composition remains on the treated surface for a period of time of at least about 1 week.

In another aspect, the present disclosure provides a cleaning composition. The cleaning composition includes a microbial biocide; and from about 0.05 to about 5 percent, by weight, of a boron-containing component which is capable of acting as both a microbial biostat and an insecticide.

In certain embodiments according to the present disclosure, the boron-containing component is preferably selected from the group consisting of disodium octaborate tetrahydrate, sodium pentaborate, sodium tetraborate, boric acid, tincal, kernite, ulexite, phenyl boronic acid, trihexylene glycol biborate and mixtures thereof

In certain other embodiments according to the present disclosure, the microbial biocide used in the cleaning composition preferably includes a cationic surfactant and the cleaning composition comprises from about 0.002 to about 2 percent, by weight, of the cationic. The cationic surfactant may, for instance, be a quaternary ammonium salt. Suitable quaternary ammonium salts may be selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof

In still other embodiments according to the present disclosure, the cleaning composition may further include from about 10 to about 4000 parts per million (ppm) of a chelating agent. In certain embodiments, this chelating agent is preferably a salt of ethylenediaminetetraacetic acid (EDTA).

Advantageously, the composition and method of the present disclosure are effective in initially cleaning and sanitizing contaminated hard surfaces such as floors and countertops. In addition, the composition and method also provide an extended microbial biostatic effect and may combine with any remaining or later present food contamination to provide an effective insecticidal bait.

In a further aspect, the present disclosure provides a method for treating a absorbent surface in order to kill insects. According to one embodiment, the method the steps of: providing an insecticide composition which includes from about 0.002 to about 2 percent, by weight, of a surfactant, preferably a cationic surfactant, and from about 0.05 to about 5 percent, by weight, of a boron-containing component which is capable of acting as an insecticide; and applying the insecticide composition to the absorbent surface so that the insecticide composition is adsorbed by the absorbent surface in an amount sufficient to kill insects. Insects then contact the absorbent surface and are killed by the adsorbed insecticide composition.

In one preferred embodiment, the absorbent surface is preferably a fabric surface. More preferably, the absorbent surface is an adsorbent material selected from the group consisting of mattresses, mattress pads, bedsheets, blankets, carpets, rugs, and combinations thererof.

In certain embodiments, the boron-containing component is preferably selected from the group consisting of boric acid, boric oxides, sodium borates, potassium borates, calcium borates, zinc borates, organic borate salts, and mixtures thereof. For instance, the boron-containing component is selected from the group consisting of disodium octaborate tetrahydrate, sodium pentaborate, sodium tetraborate, tincal, kernite, ulexite, boric acid, boronic acid, phenyl boronic acid, trihexylene glycol biborate and mixtures thereof. More preferably, the boron-containing component is disodium octaborate tetrahydrate.

In some embodiments, the surfactant preferably includes a quaternary ammonium compound. More preferably, the surfactant includes a surfactant selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof.

In still another aspect, the present disclosure provides a method for killing arthropods. In one embodiment, the method includes the steps of: providing an pesticide composition which includes from about 0.01 to about 0.8 percent, by weight, of a surfactant, preferably a cationic surfactant, and from about 0.2 to about 15 percent, by weight, of a boron-containing component; and applying the pesticide composition to a absorbent material which is infested with arthropods, so that the pesticide composition is adsorbed by the absorbent material in an amount sufficient to kill arthropods. The arthropods then contact the absorbent material and are killed by the adsorbed pesticide composition.

Preferably, the arthropods killed according to the method are selected from the group consisting of bed bugs, fleas, dust mites, and combinations thereof. More preferably, the arthropods killed are bed bugs.

In one preferred embodiment, the absorbent material is preferably a fabric. More preferably, the absorbent material is an adsorbent material selected from the group consisting of mattresses, mattress pads, bedsheets, blankets, carpets, rugs, and combinations thererof.

In certain embodiments, the boron-containing component is preferably selected from the group consisting of boric acid, boric oxides, sodium borates, potassium borates, calcium borates, zinc borates, organic borate salts, and mixtures thereof. For instance, the boron-containing component is selected from the group consisting of disodium octaborate tetrahydrate, sodium pentaborate, sodium tetraborate, tincal, kernite, ulexite, boric acid, boronic acid, phenyl boronic acid, trihexylene glycol biborate and mixtures thereof. More preferably, the boron-containing component is disodium octaborate tetrahydrate.

In some embodiments, the surfactant preferably includes a quaternary ammonium compound. More preferably, the surfactant includes a surfactant selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof.

In certain embodiments, the insecticide composition also include from about 0.1 to about 10 weight percent of a fabric softener selected from the group consisting of ethylene glycol, diethylene glycol, polyethylene glycol, glycerol, and combinations thereof.

### DETAILED DESCRIPTION

In certain embodiments, a cleaning composition is provided according to the present disclosure. The cleaning composition is generally aqueous-based and preferably includes from about 0.002 to about 2 percent, by weight, of a cationic surfactant which acts as a biocide; and from about 0.05 to about 5 percent, by weight, of a boron-containing component which is capable of acting as both a microbial biostat and an insecticide. The cleaning composition may also include a chelating agent, as well as other additives.

As used herein, the term “biocide” refers to a composition which capable of killing microorganisms. As used herein, the term “biostat” refers to a composition which is capable of suppressing the further growth of microorganisms but which is not necessarily capable of killing existing microorganisms. As used herein, the term “sanitizer” refers to a composition which is capable of acting as either a biocide and/or a biostat.

A first component of the cleaning composition is a microbial biocide. The biocide is preferably also a surfactant which aids in the removal of dirt, grease, food particles, and other contamination from the surface being cleaned. In general, suitable surfactants for use in the cleaning composition include cationic surfactants such as quaternary ammonium compounds which may also have a biocidal and/or biostatic effect and may be effective in killing and /or suppressing bacteria, viruses, and other pathogens. Examples of suitable quaternary ammonium salts which may be used in the cleaning composition include didecyl dimethyl ammonium chloride, octyl decyl dimethyl ammonium chloride, dioctyl dimethyl ammonium chloride, alkyl dimethyl benzyl ammonium chloride, and mixtures thereof. In some embodiments of the present disclosure, the cationic surfactant is a mixture of quaternary ammonium salts which includes didecyl dimethyl ammonium chloride, octyl decyl dimethyl ammonium chloride, dioctyl dimethyl ammonium chloride, and alkyl dimethyl benzyl ammonium chloride. Those of ordinary skill in the art will also appreciate that other structurally similar cationic surfactants may also be employed in the cleaning composition despite having some differences in terms of the number carbon atoms in the substituent chains and in the identity of the anion used in the salt as charge balancing counter ion. In addition to quaternary ammonium salts, the cleaning composition may also include other biocides such as hypochlorites, peroxides such as hydrogen peroxide, phenols, aldehydes, peracetic acid, alcohols such as methanol, ethanol, or isopropanol, and mixtures thereof.

The amount of cationic surfactants in the cleaning composition may range from about 0.002 weight percent to about 2 weight percent of the overall cleaning composition. In certain embodiments of the present disclosure, the amount of cationic surfactants in the cleaning composition more preferably ranges from about 0.008 weight percent to about 0.01 weight percent of the overall cleaning composition.

A second component of the cleaning composition is a boron-containing component which is capable of acting as both a microbial biostat and an insecticide on the surface being cleaned. In general, boron-containing components for use in the cleaning composition may include inorganic borates, such as disodium octaborate tetrahydrate, sodium pentaborate, sodium tetraborate, boric acid, boronic acid, tincal, kernite, ulexite and mixtures thereof. In addition, organic boron-containing components which may be used including boronic or borinic acid derivatives such as phenyl boronic acid, and borate esters such as trihexylene glycol biborate and mixtures thereof. Particularly preferred boron species in some embodiments of the present disclosure include disodium octaborate tetrahydrate and sodium pentaborate.

The amount of boron-containing component in the cleaning composition may range from about 0.05 weight percent to about 5 weight percent of the overall cleaning composition. In certain embodiments of the present disclosure, the amount of boron-containing component in the cleaning composition more preferably ranges from about 0.1 weight percent to about 1 weight percent of the overall cleaning composition.

Optionally, the cleaning composition may also include a chelating agent. In certain embodiments of the present disclosure, it is preferred to use salts of ethylenediaminetetraacetic acid (EDTA) as the chelating agent. In some embodiments according to the present disclosure, the amount of EDTA or other chelating agent in the cleaning composition may range from about 10 to about 4000 parts per million (ppm)

The amount of chelating agent in the cleaning composition may range from about 10 parts per million (ppm) to about 4000 ppm of the overall cleaning composition. In certain embodiments of the present disclosure, the amount of chelating agent in the cleaning composition more preferably ranges from about 150 ppm to about 450 ppm of the overall cleaning composition.

Optionally, the cleaning composition may also include other additives as well, such as pH buffers, stabilizers, soaps, and fragrances.

The cleaning composition may be prepared by thoroughly mixing the aforementioned components together in an aqueous solvent to provide the final cleaning composition. While the components of the cleaning composition may generally be combined in any order, in certain embodiments of the present disclosure, it may be preferred to mix the components with the aqueous solvent in a particular order so as to facilitate the mixing of the component. The mixing of the composition is preferably carried out at or near room temperature and pressure.

If desired, the cleaning composition may initially be prepared as a concentrate by reducing the initial amount of water solvent in the composition. Prior to usage, the concentrate may then be diluted to the desired strength by the addition of more water.

The cleaning composition may be used to treat and clean a wide variety of surfaces. The cleaning composition is particularly suitable in cleaning and treating hard surfaces such as floors, walls, and counter tops in restaurants, bathrooms, hotels, schools, industrial plants, and other commercial facilities. The composition may also be used to clean soft or absorbent surfaces such as carpeting and fabrics. These surfaces regularly become contaminated with dirt, grease, food particles, and other undesirable materials. In addition to being unsightly, the presence of these contaminants also provides a breeding ground for harmful microorganisms such as bacteria and other potential pathogens and a food source for insects and other arthropod pests.

The composition may be used to clean these surfaces by application in a conventional manner, such as by spraying, mopping, or with scrub brushes, or with cleaning wipes.

Used in this manner, the cleaning composition of the present disclosure is effective in substantially removing the aforementioned contaminants (dirt, grease, food particles, and so forth) from the surface. In some embodiments according to the present disclosure, the cleaning composition also preferably sanitizes the surface by killing bacteria and other harmful microorganisms present on the surface at the time of the cleaning treatment. By killing and preventing the growth of microorganisms, the cleaning composition also serves as an effective deodorizer as well.

In addition, a residual amount of the cleaning composition is left behind on the surface after the cleaning treatment is completed. In generally, from about 1 to about 99% of the solids in the cleaning composition which has been applied may be left behind as a residual after the aqueous solvent has been wiped away and/or allowed to evaporate. This residual includes an amount of the boron-containing component from the cleaning composition and thus provides an extended biostatic effect which persists after the cleaning treatment is completed. In certain embodiments of the present disclosure, this residual film will remain for at least about 1 week. Preferably, the residual cleaning composition will remain until it is purposely removed by cleaning the surface with a cleaning mixture which does not include a cationic surfactant and a boron-containing component as according to the present disclosure.

The advantageous effects of the residual film and the boron-containing component therein, are at least two-fold. First, the residual boron-containing component functions as a microbial biostatic agent which is capable of at least suppressing the growth of, and in some instances killing, bacterial and other harmful microorganisms for an extended period of time.

In addition, the residual biocide is also effective as an insecticide. After the surface has been cleaned and treated, it is inevitable that some food remnant remains or that the surface will eventually become recontaminated, at least to some degree, with insect supporting and/or attracting agents such as, grease, food particles, and the like. This is particularly true in high traffic areas. When food particles or other materials recontaminate the surface, the contaminants contact the residual material on the surface and a portion of the biocide from the material is absorbed by the food particles or other contaminants. After absorbing the boron-containing component, with its insecticidal properties, the contaminant particles themselves form insecticidal bait which is capable of killing insects which consume it.

In certain embodiments of the present disclosure, the insectidical bait thus formed may remain effective for up to about 1 week or until removed by subsequent cleaning of the surface using a different cleaning composition which is not in accordance with the present disclosure.

The composition of the present disclosure may also be used to kill insects or other anthropods by itself, without being mixed or commingled with food remnants. For instance, the composition may be used to kill arthropods such as bed bugs, fleas, and/or dust mites. The composition has been found to be particularly suitable for killing bed bugs.

In such applications, the composition may be applied to a soft or absorbent material, such as a fabric material. For instance, the composition may be applied to an adsorbent material selected from the group consisting of mattresses, mattress pads, bedsheets, blankets, carpets, rugs, and combinations thereof. In other embodiments, the composition may also be applied on or behind baseboards, where insects such as bed bugs, as well as other arthropods, tend to live.

When applied to kill the aforementioned insects and other anthropods, the composition, according to one embodiment, may include from about 0.002 to about 2 percent, by weight, of a surfactant and from about 0.05 to about 5 percent, by weight, of a boron-containing component which is capable of acting as an insecticide. In another embodiment, the composition may include from about 0.01 to about 0.8 percent, by weight, of a surfactant and from about 0.2 to about 15 percent, by weight, of a boron-containing component. The composition is applied to and adsorbed by the soft or absorbent material in an amount sufficient to kill the bed bugs or other anthropods.

Preferred boron-containing component for the composition include boric acid, boric oxides, sodium borates, potassium borates, calcium borates, zinc borates, organic borate salts, and mixtures thereof. For instance, the boron-containing component may be selected from the group consisting of disodium octaborate tetrahydrate, sodium pentaborate, sodium tetraborate, tincal, kernite, ulexite, boric acid, boronic acid, phenyl boronic acid, trihexylene glycol biborate and mixtures thereof. More preferably, the boron-containing component is disodium octaborate tetrahydrate.

In general, the surfactant is preferably a cationic surfactant, such as a quaternary ammonium compound. More preferably, the cationic surfactant includes a surfactant selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof.

In certain embodiments, the insecticide composition may also include from about 0.1 to about 10 weight percent of a fabric softener. This fabric softener may be selected from the group consisting of ethylene glycol, diethylene glycol, polyethylene glycol, glycerol, and combinations thereof.

The following nonlimiting examples illustrate various additional aspects of the invention. Unless otherwise indicated, temperatures are in degrees Celsius and percentages are by weight based on the dry weight of the formulation.

### EXAMPLE 1

In this example, an exemplary disinfecting and insecticidal floor cleaning composition according to the present disclosure was prepared including 15 grams of disodium octaborate tetrahydrate, 3.44 grams of MAQUAT MQ624M, 2.5 grams of VERSENE 100, 0.25 grams of sodium carbonate, and 0.1 grams of a lemon fragrance additive. These components were thoroughly mixed in sufficient water to make a 1 liter solution of the cleaning composition. MAQUAT MQ624M is a mixture of cationic quaternary ammonium surfactants, including octyl decyl dimethyl ammonium chloride, didecyl dimethyl ammonium chloride, dioctyl dimethyl ammonium chloride, and alkyl dimethyl benzyl ammonium chloride which is commercially available from Mason Chemical Company of Arlington Height, Ill. VERSENE 100 is a chelating agent in an aqueous solution of the tetrasodium salt of ethylenediaminetetraacetic acid commercially available from Dow Chemical.

This composition was tested as a household cleaning solution and was found to be effective in removing (1) black shoe scuff marks and soil from a laboratory ceramic tiled floor; (2) food, grease and dirt build up from a domestic kitchen ceramic tiled floor; (3) dirt from a domestic carpet, (4) scum from around the water mark of a hot tub; and (5) built up residue from a shower stall.

The effectiveness of this composition as a sanitizer and as an insecticide was then tested. To test the effectiveness of the composition as an antimicrobial sanitizer, two test chambers were prepared from 10 inch by 16 inch STERILITE plastic containers with lids, available from Sterilite Corporation of Townsend, Mass.

A representative ‘food material contamination’ was prepared consisting of sugar, egg, vegetable oil, and corn flour, carried on corn cob grit. A 0.6 g sample of this food material contamination was spread in each plastic container along with 14 g of a 2% weight/weight solution of malt extract in water. These additions were carried out under normal laboratory conditions and were not sterile. The two test chambers were then incubated at approximately 20° C. for 72 hours in order to allow bacteria and other microorganisms to grow within the chambers.

After the incubation period, one of the containers was sprayed with a small volume (about 20-30 ml) of the foregoing cleaning composition on all interior surfaces. The second container was used as a control and was sprayed with an equivalent volume of sterile deionized water on all interior surfaces. A 1 ml sample of liquid was taken from each of the chambers using sterile Pasteur pipettes for standard serial dilution and pour plate microbial assay. These 1 ml samples were then diluted by a factor of 10 by addition of 9 ml of sterile deionized water. A 1 ml sample from each first dilution was retained, and then 1 ml of each first dilution was diluted a second time with sterile deionized water by another factor of 10 (overall dilution of 100). A 1 ml sample of each second dilution was also retained, and then 1 ml of each second dilution was diluted a third time with sterile deionized water by another factor of 10 (overall dilution of 1000). A 1 ml sample of each third dilution was also retained. Each of the 1 ml dilution samples was then plated out in separate 9 cm diameter sterile Petri dishes with an aqueous 2 weight % malt extract 2 weight % agar at 45° C. (after having been left to cool to about 45° C. following autoclave sterilization at 120° C. for 20 minutes).

The resulting inoculated malt agar plates were then left to set and incubated for a period of 3 days at approximately 20° C. After 3 days, the Petri dishes were visually examined and all bacterial or microorganism growth found in the agar media was counted, where possible, to determine the number of colony forming units (CFUs) in each Petri dish. This count was taken as an indication of the total number of live or viable microorganisms in each of the original 1 ml samples. The CFUs counted are tabulated in Table I.

TABLE I
Count of Colony Forming Units (CFUs)

| | | Samples Treated with |
|---|---|---|
| Dilution Sampled | Control Samples | Inventive Composition |
| 1^{st} dilution (×10) | Too many CFUs to count | 0 CFU |
| 2^{nd} dilution (×100) | 277 CFU | 0 CFU |
| 3^{rd} dilution (×1000) | 34 CFU | 0 CFU |

By taking the number of colony forming units counted in the second and third dilution samples and multiplying these counts times the overall dilution factors of 100 and 1000, respectively, it may be estimated that the initial 1 ml sample taken from the control test chamber contained from about 27,700 to about 34,000 (average of 30,850) viable microorganism cells. In contrast, all of the dilution samples taken from test chamber treated with the composition contained 0 viable microorganism cells. Thus, the composition was found to be extremely effective as a sanitizer and disinfectant.

Following the sanitizer test, the same test chambers were than allowed to air dry (lids removed) to remove excess moisture and then used to test the effectiveness of the composition as an insecticide.

20 g of water was applied to cotton bats in Petri dishes. One dish was then added to each test chamber to provide a water source and to maintain some humidity in the test chambers. The cotton bats were kept moist for the duration of the test.

Common field crickets (Acheta domesticus) were then added to each test chamber, with a total of 10 crickets in each test chamber. The number of live and dead crickets in each container was counted every day for a period of seven days (except day 6). During this time, the crickets' only food sources were the residual food material contamination and malt extract which were originally placed in the test chambers. The numbers of dead crickets observed are recorded in Table II below.

TABLE II
Numbers of Dead Crickets Observed

| Day of Observation | Control Test Chamber | Treated Test Chamber |
|---|---|---|
| Day 0 | 0 | 0 |
| (start) | | |
| Day 1 | 0 | 3 |
| Day 2 | 1 | 4 |
| Day 3 | 2 | 7 |
| Day 4 | 2 | 9 |
| Day 5 | 3 | 10 |
| Day 7 | 5 | 10 |

These results demonstrate the insecticidal effect of the composition in the treated test chamber. The cricket mortality was significantly higher in the composition treated test chamber than in the control test chamber. Moreover, insecticidal effects were observed rapidly, with a 30% mortality rate after only 1 day and a 70% mortality rate after only three day. The mortality rates are believed to be a result of the residual borate from the composition mixing with the residual food contamination which was ingested by the crickets.

It can be seen from the results gained that the example composition of the current disclosed invention is both an effective sanitizer and insecticide and when used to clean floors of restaurants, kitchens, hospitals etc will provide a unique and positive control of both microbial (bacterial, fungal and viral) and insect pests that otherwise thrive in these situations and result in the transmittance of various diseases and illnesses.

### EXAMPLE 2

### Effectiveness in Killing Bed Bugs

In this Example, tests were conducted to determine the effectiveness of a composition combining a borate component with a quaternary ammonium component in killing bed bugs. Comparative tests were also conducted using other compositions.

Two trials were conducted. In each trial, two different pesticide compositions where tested, along with a control which included only water with no pesticidally active ingredient.

In both Trial 1 and Trial 2, the makeup of the compositions was as follows:

| | Active Components |
|---|---|
| Test Composition | (all percentages after dilution with water) |
| Control | Water Only |
| Nisus BORA-CARE | 8.5 wt. % disodium octaborate tetrahydrate (DOT) |
| Nisus PENASHIELD | 8.5 wt. % DOT and 0.5 wt. % didecyl dimethyl |
| | ammonium chloride (DDAC) |

In each trial, a set of zipper cases were used to provide dark, enclosed environments in which to test the effectiveness of the compositions. A total 9 zipper cases were used in each trial—3 replicates for each composition being tested.

For each test, a single piece of filter paper was initially placed in each zipper case as an adsorbent material. Ten (10) bed bugs of the species Cimex lectularius were also placed in each zipper case. The beg bugs and filter paper in each zipper case were then sprayed with a total of about 1.5 milliliters of one of the treatment compositions. After application of the treatment composition, each of the zipper cases were covered with fine mesh and secured with a tight fitting rubber band in order to prevent escape of the bed bugs.

The zipper cases were then maintained in a laboratory at room temperature for 1 month. During the time, the number of live bed bugs and dead bugs was observed and recorded periodically. Observations were made and recorded 1 hour after application of the treatment composition; once a day for the first 5 days after the application of the treatment composition; and then once a week for the remainder of the month following application of the treatment composition. The results are summarized in the following tables:

Trial 1 Results

| | Average Percent Mortality | | |
|---|---|---|---|
| Time | Control | BORA-CARE | PENASHIELD |
| 1 Hr. | 0 | 0 | 0 |
| Day 1 | 0 | 0 | 66.7 |
| Day 2 | 0 | 0 | 80 |
| Day 3 | 0 | 0 | 83.3 |
| Day 4 | 0 | 0 | 93.3 |
| Day 5 | 0 | 0 | 96.7 |
| Week 1 | 0 | 0 | 100 |
| Week 2 | 13.3 | 33.3 | 100 |
| Week 3 | 33.3 | 83.3 | 100 |
| Week 4 | 33.3 | 100 | 100 |

Trial 2 Results

| | Average Percent Mortality | | |
|---|---|---|---|
| Time | Control | BORA-CARE | PENASHIELD |
| 1 Hr. | 0 | 0 | 90 |
| Day 1 | 13.3 | 20 | 100 |
| Day 2 | 13.3 | 23.3 | 100 |
| Day 3 | 13.3 | 23.3 | 100 |
| Day 4 | 13.3 | 23.3 | 100 |
| Day 5 | 16.7 | 23.3 | 100 |
| Week 1 | 16.7 | 36. | 100 |
| Week 2 | 30 | 66.7 | 100 |
| Week 3 | 36.7 | 96.7 | 100 |
| Week 4 | 46.7 | 100 | 100 |

These results demonstrate that borates alone (in the form of BORA-CARE) exhibits some, limited effective in killing bed bugs, particularly over an extended time (longer than 1 week).

However, when the borates are combined with only a small amount of quaternary ammoniums salts (in the PENASHIELD formulation) the resultant composition exhibits a surprising and dramatic improvement in effectiveness in killing bed bugs. The PENASHIELD mixture not only kills bed bugs much faster than borates alone (BORA-CARE), but also achieved 100% lethality.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for treating a absorbent surface in order to kill insects, the method comprising the steps of:
providing an insecticide composition which includes from about 0.002 to about 2 percent, by weight, of a surfactant and from about 0.05 to about 5 percent, by weight, of a boron-containing component which is capable of acting as an insecticide; and
applying the insecticide composition to the absorbent surface so that the insecticide composition is adsorbed by the absorbent surface in an amount sufficient to kill insects,
wherein insects contact the absorbent surface and are killed by the adsorbed insecticide composition.

2. The method of claim 1, wherein the absorbent surface is a fabric surface.

3. The method of claim 1, wherein the absorbent surface is an adsorbent material selected from the group consisting of mattresses, mattress pads, bedsheets, blankets, carpets, rugs, and combinations thererof.

4. The method of claim 1, wherein the boron-containing component is selected from the group consisting of boric acid, boric oxides, sodium borates, potassium borates, calcium borates, zinc borates, organic borate salts, and mixtures thereof.

5. The method of claim 1, wherein the boron-containing component is selected from the group consisting of disodium octaborate tetrahydrate, sodium pentaborate, sodium tetraborate, tincal, kernite, ulexite, boric acid, boronic acid, phenyl boronic acid, trihexylene glycol biborate and mixtures thereof.

6. The method of claim 1, wherein the boron-containing component is disodium octaborate tetrahydrate.

7. The method of claim 1, wherein the surfactant comprises a quaternary ammonium compound.

8. The method of claim 1, wherein the surfactant comprises a surfactant selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof.

9. A method for killing arthropods, the method comprising the steps of:
providing an pesticide composition which includes from about 0.01 to about 0.8 percent, by weight, of a surfactant and from about 0.2 to about 15 percent, by weight, of a boron-containing component; and
applying the pesticide composition to a absorbent material which is infested with arthropods, so that the pesticide composition is adsorbed by the absorbent material in an amount sufficient to kill arthropods,
wherein the arthropods contact the absorbent material and are killed by the adsorbed pesticide composition.

10. The method of claim 9, wherein the arthropods killed are selected from the group consisting of bed bugs, fleas, dust mites, and combinations thereof.

11. The method of claim 9, wherein the arthropods killed are bed bugs.

12. The method of claim 9, wherein the absorbent material is a fabric.

13. The method of claim 9, wherein the absorbent material is an adsorbent material selected from the group consisting of mattresses, mattress pads, bedsheets, blankets, carpets, rugs, and combinations thererof.

14. The method of claim 9, wherein the boron-containing component is selected from the group consisting of boric acid, boric oxides, sodium borates, potassium borates, calcium borates, zinc borates, organic borate salts, and mixtures thereof.

15. The method of claim 9, wherein the boron-containing component is selected from the group consisting of disodium octaborate tetrahydrate, sodium pentaborate, sodium tetraborate, tincal, kernite, ulexite, boric acid, boronic acid, phenyl boronic acid, trihexylene glycol biborate and mixtures thereof.

16. The method of claim 9, wherein the boron-containing component is disodium octaborate tetrahydrate.

17. The method of claim 9, wherein the surfactant comprises a quaternary ammonium compound.

18. The method of claim 9, wherein the surfactant comprises a surfactant selected from the group consisting of didecyl dimethyl ammonium chloride, octyl decyl dimethyl ammonium chloride, dioctyl dimethyl ammonium chloride, alkyl dimethyl benzyl ammonium chloride, and mixtures thereof.

19. The method of claim 9, wherein the insecticide composition further includes from about 0.1 to about 10 weight percent of a fabric softener selected from the group consisting of ethylene glycol, diethylene glycol, polyethylene glycol, glycerol, and combinations thereof.
